(19) United States
(12) Patent Application Publication
(10) Pub. No.: US 2026/0295500 A1
(43) Pub. Date: Oct. 1, 2026

(54) DAC APPARATUS

(71) Applicant: Honda Motor Co., Ltd., Tokyo (JP)

(72) Inventors: Wataru Noguchi, Saitama (JP); Shumon Hoshino, Saitama (JP)

(21) Appl. No.: 19/574,318

(22) Filed: Mar. 21, 2026

(30) Foreign Application Priority Data
Mar. 28, 2025 (JP) 2025-055210

(51) Int. Cl. B01D 53/04; B01D 53/26

(52) U.S. Cl. CPC B01D 53/0446; B01D 53/0438; B01D 53/0454; B01D 53/265; B01D 2257/504; B01D 2257/80

(57) ABSTRACT

A DAC apparatus to recover CO₂ in atmosphere, includes: an adsorption chamber provided with adsorbent for adsorbing or absorbing CO₂ and water; a vacuum pump for recovery connected with the adsorption chamber through vacuum piping for recovery and to suck a desorption gas from the adsorbent; a vacuum pump for deaeration connected with the adsorption chamber through vacuum piping for deaeration and to suck residual atmosphere not absorbed to the adsorbent; a gas-liquid separator provided on vacuum piping for recovery and to separate water from the desorption gas; a first water tank to store water separated by the gas-liquid separator; a second water tank connected with the vacuum piping for deaeration; a communication passage communicating the first water tank with the second water tank; an on-off valve provided on the communication passage; and a controller to control the on-off valve.

### CROSS-REFERENCE TO RELATED APPLICATION

This application is based upon and claims the benefit of priority from Japanese Patent Application No. 2025-055210 filed on Mar. 28, 2025, the content of which is incorporated herein by reference.

### BACKGROUND OF THE INVENTION

### Filed of the invention

The present invention relates to a direct air capture (DAC) apparatus that recovers carbon dioxide (CO₂) in the atmosphere.

### Description of the related art

For the purpose of mitigating climate changes, research and development have been conducted on DAC technology for recovering CO₂, which is a main greenhouse gas. As such a DAC technology, a DAC apparatus that recovers CO₂ in the atmosphere using an adsorbent for adsorbing or absorbing CO₂ is known. For example, in the DAC apparatus of JP 2024-048937 A, after the atmosphere is circulated into an adsorption chamber in which an adsorbent is provided to adsorb CO₂ in the atmosphere to the adsorbent, the inside of the adsorption chamber is depressurized using a vacuum pump to desorb CO₂ from the adsorbent. Thus, a desorption gas having a high CO₂ concentration is recovered.

However, in a case where CO₂ is recovered using a vacuum pump as in the DAC apparatus described in JP 2024-048937 A, pump efficiency may decrease due to water desorbed together with CO₂, and CO₂ recovery efficiency may decrease as the entire apparatus.

### SUMMARY OF THE INVENTION

An aspect of the present invention is a DAC apparatus configured to recover CO₂ in the atmosphere, including: an adsorption chamber provided with an adsorbent for adsorbing or absorbing CO₂ and water; a vacuum pump for recovery connected with the adsorption chamber through vacuum piping for recovery and configured to suck desorption gas from the adsorbent; a vacuum pump for deaeration connected with the adsorption chamber through vacuum piping for deaeration and configured to suck residual atmosphere not absorbed to the adsorbent; a gas-liquid separator provided on the vacuum piping for recovery and configured to separate water from the desorption gas; a first water tank configured to store the water separated by the gas-liquid separator; a second water tank connected with the vacuum piping for deaeration; a communication passage communicating the first water tank with the second water tank; an on-off valve provided on the communication passage; and a controller configured to control the on-off valve for a water level of the first water tank to exceed a lower limit water level.

### BRIEF DESCRIPTION OF THE DRAWINGS

The objects, features, and advantages of the present invention will become clearer from the following description of embodiments in relation to the attached drawings, in which:

FIG. 1 is a block diagram schematically illustrating an example of a piping configuration of a DAC apparatus according to an embodiment of the present invention;

FIG. 2 is a block diagram schematically illustrating an example of a piping configuration in the surroundings of a gas-liquid separator provided on vacuum piping shown in FIG. 1;

FIG. 3 is a diagram for describing the gas-liquid separator shown in FIG. 2;

FIG. 4 is a block diagram schematically illustrating an example of a control configuration of the DAC apparatus according to the embodiment of the present invention;

FIG. 5 is a flowchart illustrating an example of transfer processing performed by a controller shown in FIG. 4; and

FIG. 6 is a flowchart illustrating an example of water drain processing performed by the controller shown in FIG. 4.

### DETAILED DESCRIPTION OF THE INVENTION

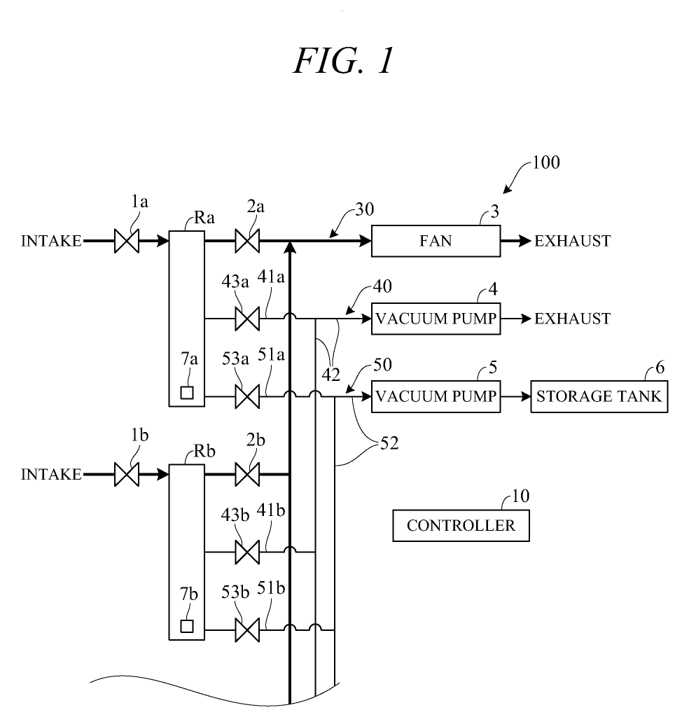

Hereinafter, embodiments of the present invention will be described with reference to FIGS. 1-6. FIG. 1 is a block diagram schematically illustrating an example of a piping configuration of a DAC apparatus 100 according to an embodiment of the present invention. As illustrated in FIG. 1, the DAC apparatus 100 mainly includes a plurality of reactors R (Ra, Rb, and so on) in each of which an adsorbent for adsorbing or absorbing CO₂ is provided.

The reactor R includes a housing in which a sealed space (an adsorption chamber) can be formed, and an adsorbent is provided in the adsorption chamber of the reactor R. As the adsorbent, a solid material composed to adsorb CO₂ at normal temperature and normal pressure and to desorb CO₂ as the temperature rises can be used. For example, an amine-based solid absorbent in which an amine-based compound is carried on an appropriate carrier can be used. Such an adsorbent adsorbs or absorbs water in addition to CO₂. The adsorbent is constituted in an appropriate granular shape, is filled in a filter cartridge or the like having a mesh structure, for example, and is accommodated in the adsorption chamber of the reactor R.

Atmospheric control valves 1 (1a, 1b, and so on) and 2 (2a, 2b, and so on), which open the reactor R to the atmosphere or seal the reactor R from the atmosphere, are provided for the reactor R. The atmospheric control valves 1 and 2 may be provided on piping that connects the adsorption chamber of the reactor R with an external space, or may be provided as a part of a housing (a wall surface) of the reactor R. When the atmospheric control valves 1 and 2 are opened, the adsorption chamber of the reactor R is opened to the atmosphere. When the atmospheric control valves 1 and 2 are closed, the adsorption chamber of the reactor R is sealed. The atmospheric control valve 1 and the atmospheric control valve 2 are provided to face each other with the adsorption chamber interposed between them.

A fan 3 for circulating the atmosphere into the adsorption chamber of the reactor R is connected with the reactor R through appropriate piping (atmospheric piping) 30 and one of the atmospheric control valves 1 and 2 (the atmospheric control valve 2 in the illustrated example). In the illustrated example, when the atmospheric control valves 1 and 2 are open and the fan 3 is driven, the atmosphere is taken into the reactor R through the atmospheric control valve 1, and the atmosphere is exhausted from the reactor R through the atmospheric control valve 2, the atmospheric piping 30, and the fan 3. Thus, when the atmosphere circulates into the reactor R, CO₂ in the atmosphere is adsorbed to the adsorbent in the adsorption chamber (an adsorption step). The atmospheric control valves 1 and 2 and the atmospheric piping 30 are each configured to have a relatively large diameter so as to enable a large amount of atmosphere to circulate into the reactor R. A plurality of atmospheric control valves 1 and a plurality of atmospheric control valves 2 may be provided.

Vacuum piping 40 is further connected with the reactor R. The vacuum piping 40 connects the adsorption chamber of the reactor R with an intake port of a vacuum pump 4. More specifically, the vacuum piping 40 includes: individual piping 41 (41a, 41b, and so on), which communicates with the adsorption chamber of each reactor R; and junction piping 42, which joins the individual piping 41 to communicate with the intake port of the vacuum pump 4, and thus connects the individual piping 41 with the vacuum pump 4.

On each individual piping 41, a vacuum control valve 43 (43a, 43b, and so on), which permits or prohibits the flow of gas in the individual piping 41, that is, the flow from the reactor R to the vacuum piping 40, is provided. The vacuum control valve 43 may be made up of an on-off valve such as a ball valve, may be made up of an adjustment valve such as a butterfly valve, or may be made up of a combination of them.

When the adsorption step ends, the atmospheric control valves 1 and 2 are closed, and in addition, the vacuum control valve 43 is opened. The gas in the adsorption chamber of the reactor R is sucked out by the vacuum pump 4 through the vacuum piping 40, and is exhausted. Thus, the residual atmosphere in the adsorption chamber of the reactor R, more specifically, the gas such as oxygen that is not adsorbed to the adsorbent is sucked out of the reactor R, and is deaerated. The inside of the adsorption chamber of the reactor R is depressurized from normal pressure (atmospheric pressure) to the final ultimate pressure of the vacuum pump 4 (a deaeration step).

Vacuum piping 50 is further connected with the reactor R. The vacuum piping 50 connects the adsorption chamber of the reactor R with an intake port of a vacuum pump 5. A storage tank 6 is connected with an exhaust port of the vacuum pump 5 through appropriate piping. More specifically, the vacuum piping 50 includes: individual piping 51 (51a, 51b, and so on), which communicates with the adsorption chamber of each reactor R; and junction piping 52, which joins the individual piping 51 to communicate with the intake port of the vacuum pump 5, and thus connects the individual piping 51 with the vacuum pump 5.

On each piece of the individual piping 51, a vacuum control valve 53 (53a, 53b, and so on), which permits or prohibits the flow of gas in the individual piping 51, that is, the flow from the reactor R to the vacuum piping 50, is provided. Similarly to the vacuum control valve 43, the vacuum control valve 53 may be made up of an on-off valve such as a ball valve, may be made up of an adjustment valve such as a butterfly valve, or may be made up of a combination of them.

In the reactor R, a heating device that heats the adsorbent and a cooling device that cools the adsorbent are also provided. For example, a heat exchanger 7 (7a, 7b, and so on), which heats or cools the adsorbent, is provided.

When the deaeration step ends, the atmospheric control valves 1 and 2 and the vacuum control valve 43 are closed, and in addition, the vacuum control valve 53 is opened. The adsorbent in the adsorption chamber is heated by the heat exchanger 7, and the gas in the adsorption chamber of the reactor R is sucked out by the vacuum pump 5 through the vacuum piping 50. Thus, CO₂ that has been adsorbed to the adsorbent of the reactor R is desorbed, and the desorption gas mainly containing the desorbed CO₂ is sucked out of the reactor R, is stored in the storage tank 6, and is recovered. In addition, the inside of the adsorption chamber is maintained to be closer to the final ultimate pressure of the vacuum pump 5 (a desorption step).

When the desorption step ends, the atmospheric control valves 1 and 2 and the vacuum control valves 43 and 53 are closed, and the adsorbent in the adsorption chamber is cooled by the heat exchanger 7 (a cooling step). In a case where the adsorbent is heated in the desorption step, if the adsorbent becomes a high temperature in a state in which oxygen is present in the adsorption chamber, the adsorbent may be subject to oxidation deterioration. By deaerating the residual atmosphere containing oxygen in the deaeration step, and then starting the desorption step of heating the adsorbent, and in addition, after the desorption step, by cooling the adsorbent in the cooling step, and then starting the adsorption step of circulating the atmosphere into the adsorption chamber, it becomes possible to prevent the oxidation deterioration of the adsorbent.

The DAC apparatus 100 includes a controller 10, which controls each unit of the DAC apparatus 100 including the atmospheric control valves 1 and 2, the fan 3, the vacuum pumps 4 and 5, the heat exchanger 7, and the vacuum control valves 43 and 53. The controller 10 is made up of a computer including a CPU, a ROM, a RAM, an I/O interface, and other peripheral circuits. The controller 10 controls each unit of the DAC apparatus 100 so that the adsorption step, the deaeration step, the desorption step, and the cooling step are sequentially performed in the plurality of reactors R by shifting the timing.

More specifically, in a state in which the fan 3 and the vacuum pumps 4 and 5 are driven, each unit of the DAC apparatus 100 is controlled in such a manner that the atmospheric control valves 1 and 2 are open and the vacuum control valves 43 and 53 are closed in the adsorption step, the atmospheric control valves 1 and 2 and the vacuum control valve 53 are closed and the vacuum control valve 43 is open in the deaeration step, the atmospheric control valves 1 and 2 and the vacuum control valve 43 are closed and the vacuum control valve 53 is open and the adsorbent is heated in the desorption step, and the atmospheric control valves 1 and 2 and the vacuum control valves 43 and 53 are closed and the adsorbent is cooled in the cooling step.

In the desorption step, CO₂ and water that has been adsorbed to the adsorbent are desorbed. More specifically, when the temperature of the adsorbent reaches a desorption temperature of water (for example, approximately 70 degrees Celsius), water is desorbed. Then, when the temperature reaches a desorption temperature of CO₂ (for example, approximately 100 degrees Celsius), which is higher than the desorption temperature of water, CO₂ is desorbed. Therefore, in the present embodiment, the DAC apparatus 100 is configured as follows in such a manner that a gas-liquid separator is provided on the vacuum piping 50 to remove water from the desorption gas, and the pump efficiency of the vacuum pump 5 is improved, so that the CO₂ recovery efficiency of the entire apparatus can be improved.

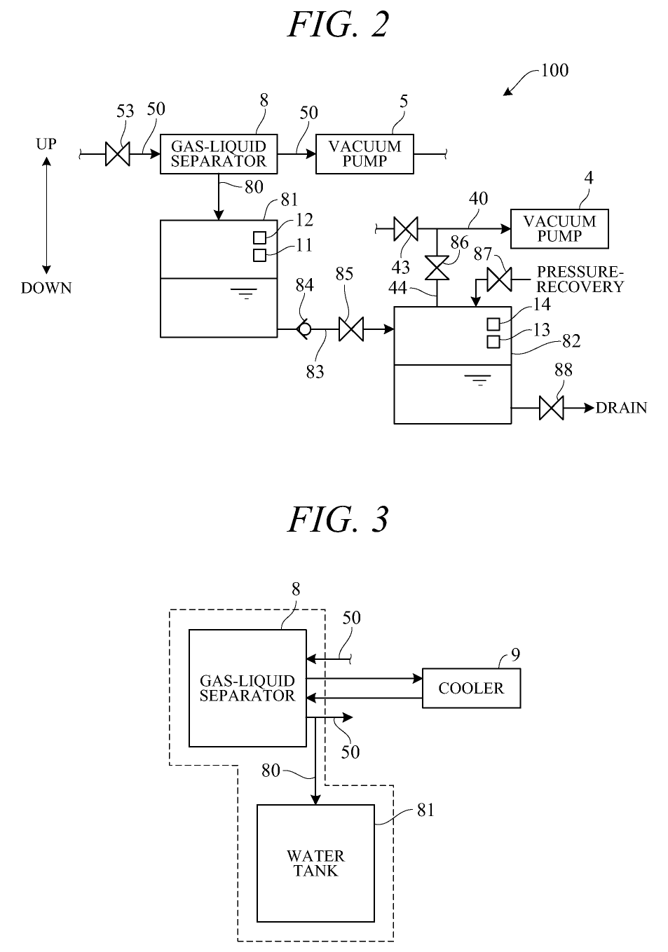

FIG. 2 is a block diagram schematically illustrating an example of a piping configuration in the surroundings of a gas-liquid separator 8, which is provided on the vacuum piping 50, and FIG. 3 is a diagram for describing the gas-liquid separator 8. The gas-liquid separator 8 may be provided on the junction piping 52, which is disposed immediately before (upstream) the vacuum pump 5 in the vacuum piping 50 of FIG. 1, or may be provided on the individual piping 51 of each reactor R. In a case of grouping the plurality of reactors R as a reactor group and providing group junction piping in which the individual piping 51 of each reactor group is joined to communicate with the junction piping 52, the gas-liquid separator 8 may be provided on the group junction piping.

As illustrated in FIGS. 2 and 3, the gas-liquid separator 8 is provided on the vacuum piping 50 between the reactor R and the vacuum pump 5 for CO₂ recovery, and separates water from the desorption gas. Hereinafter, the vacuum pump 5 for CO₂ recovery will be referred to as a “vacuum pump for recovery”, and the vacuum piping 50 will be referred to as a “vacuum piping for recovery”, in some cases. The gas-liquid separator 8 is, for example, a condenser such as a plate heat exchanger that cools and condenses water vapor in the desorption gas using a refrigerant such as water, and a flow passage through which the refrigerant from a cooler 9 and the desorption gas from the vacuum piping 50 alternately flow is formed inside the gas-liquid separator 8.

A first water tank 81 is connected through appropriate branch piping 80 with the vacuum piping 50, which is immediately after (downstream) the gas-liquid separator 8, and the water that has been separated by the gas-liquid separator 8 is stored in the first water tank 81. The branch piping 80 connects the vacuum piping 50 with an upper surface of first water tank 81. In the first water tank 81, a water level sensor 11, which detects a water level L1 of condensed water stored in the first water tank 81, and a pressure sensor 12, which detects pressure P1 of a gas phase of the first water tank 81, are provided. Detection values of the water level sensor 11 and the pressure sensor 12 are transmitted to the controller 10.

By providing the gas-liquid separator 8 on the vacuum piping 50 between the reactor R and the vacuum pump 5, and separating and removing water (water vapor) from the desorption gas, it becomes possible to reduce the pressure of the desorption gas in the vacuum piping 50 in accordance with the partial pressure of the water vapor removed by the gas-liquid separator 8. Thus, the pump efficiency and the CO₂ recovery efficiency of the vacuum pump 5 can be improved in the former half of the desorption step in which the desorption amount of water is particularly large, and the CO₂ recovery efficiency of the entire apparatus can be improved. In addition, by removing moisture from the desorption gas and then recovering the desorption gas, it becomes possible to further increase the concentration of CO₂ to be recovered in the storage tank 6. Further, by using a heat exchanger as the gas-liquid separator 8, it is possible to separate water from the desorption gas with a simple configuration.

As illustrated in FIG. 3, the gas-liquid separator 8 and the first water tank 81 are thermally insulated. Thus, when the condensed water is vaporized (re-evaporated) in the gas-liquid separator 8 and the first water tank 81, the temperatures of the gas-liquid separator 8 and the first water tank 81 are lowered by the heat of vaporization, so that the water vapor is immediately condensed, and re-evaporation of the condensed water is suppressed as a whole. In addition, the gas-liquid separator 8 and the first water tank 81 are maintained at cryogenic temperature and condensed water at cryogenic temperature is stored, and thus such condensed water at cryogenic temperature can be used for cooling or the like of other equipment (for example, the vacuum pumps 4 and 5).

As illustrated in FIG. 2, a second water tank 82 is connected through appropriate branch piping 44 with the vacuum piping 40, which is disposed between the reactor R and the vacuum pump 4 for deaeration. Hereinafter, the vacuum pump 4 for deaeration will be referred to as a “vacuum pump for deaeration”, and the vacuum piping 40 will be referred to as “vacuum piping for deaeration”, in some cases. The branch piping 44 connects the vacuum piping 40 with an upper surface of the second water tank 82. In the second water tank 82, a water level sensor 13, which detects a water level L2 of the condensed water stored in the second water tank 82, and a pressure sensor 14, which detects pressure P2 of the gas phase of the second water tank 82, are provided. Detection values of the water level sensor 13 and the pressure sensor 14 are transmitted to the controller 10.

The second water tank 82 is disposed to be lower than the first water tank 81 in a gravity direction, a lower portion of the first water tank 81 and an upper portion of a side surface of the second water tank 82 are connected with each other through a communication passage 83, and the liquid phase of the first water tank 81 and the gas phase of the second water tank 82 are communicated with each other through the communication passage 83. Thus, it becomes possible to transfer the condensed water stored in the first water tank 81 to the second water tank 82 through the communication passage 83 in accordance with gravity. The condensed water that has been transferred from the first water tank 81 to the second water tank 82 is stored in the second water tank 82.

The second water tank 82 is connected with the vacuum piping 40 through the branch piping 44, which is connected with an upper surface of the second water tank 82, and is connected with the first water tank 81 through the communication passage 83, which is connected with an upper portion of a side surface of the second water tank 82. In this manner, by connecting the branch piping 44 to be higher than the communication passage 83, it becomes possible to certainly prevent the condensed water that has been transferred from the first water tank 81 to the second water tank 82 from flowing into the vacuum piping 40 through the branch piping 44.

As illustrated in FIG. 2, the communication passage 83 may connect a lower portion of a side surface of the first water tank 81 with the upper portion of the side surface of the second water tank 82, or may connect a lower surface of the first water tank 81 with the upper portion of the side surface of the second water tank 82. In addition, as illustrated in FIG. 2, the communication passage 83 may be provided to extend in the horizontal direction, may be provided to extend in the vertical direction, or may be provided to be inclined.

On the communication passage 83, a check valve 84, which blocks the flow of the fluid from the second water tank 82 to the first water tank 81, and an on-off valve (a control valve) 85 are provided. When the on-off valve 85 is open, it is possible to transfer the condensed water from the first water tank 81 to the second water tank 82. Hereinafter, the on-off valve 85 will be referred to as the transfer valve 85.

An on-off valve (a control valve) 86 is provided on the branch piping 44. When the on-off valve 86 is open, the second water tank 82 is depressurized by the vacuum pump 4 through the branch piping 44 and the vacuum piping 40. Hereinafter, the on-off valve 86 will be referred to as the depressurizing valve 86.

A pressure recovery valve (a control valve) 87 is provided on the upper surface of the second water tank 82, and a drain valve (a control valve) 88 is provided on a lower portion of the second water tank 82. The drain valve 88 may be provided on a side surface of the second water tank 82 as illustrated in FIG. 2, or may be provided on a lower surface of the second water tank 82. As illustrated in FIG. 2, the pressure recovery valve 87 and the drain valve 88 each may be provided on piping that connects a storage space of the second water tank 82 with an external space, or may be provided directly on a wall surface of the second water tank 82. The control valves 85 to 88 are controlled by the controller 10.

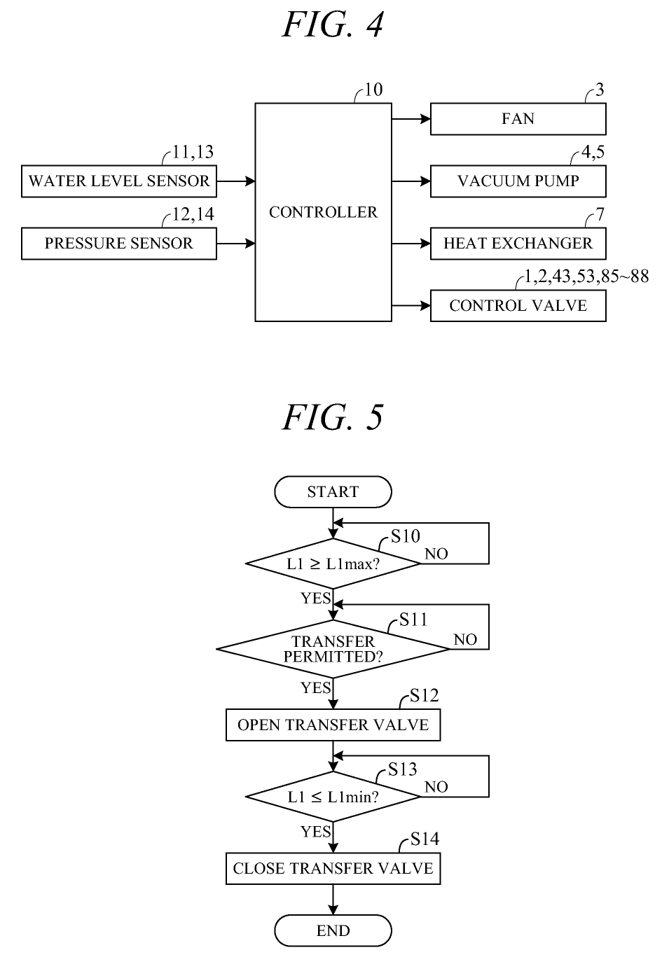

FIG. 4 is a block diagram schematically illustrating an example of a control configuration of the DAC apparatus 100. As illustrated in FIG. 4, the water level sensors 11 and 13 and the pressure sensors 12 and 14 are connected with the controller 10, and a signal indicating a detection value of each sensor is input into the controller 10. In addition, each unit of the DAC apparatus 100, which includes the fan 3, the vacuum pumps 4 and 5, the heat exchanger 7, and the control valves 1, 2, 43, 53, and 85 to 88, is connected with the controller 10, and a control signal is transmitted from the controller 10 to each unit of the DAC apparatus 100.

When the DAC apparatus 100 is activated, the controller 10 controls the control valves 1, 2, 43, 53, and 85 to 88, while driving the fan 3 and the vacuum pumps 4 and 5. Therefore, the vacuum piping 40 and the vacuum piping 50 are always maintained near the final ultimate pressure of the vacuum pumps 4 and 5. The residual atmosphere from the reactor R in the deaeration step periodically flows into the vacuum piping 40 for deaeration, and the desorption gas from the reactor R in the desorption step periodically flows into the vacuum piping 50 for CO₂ recovery. The deaeration step is extremely shorter than the desorption step, and the pressure rise of the vacuum piping 40 due to the residual atmosphere from the reactor R in the deaeration step is extremely smaller than the pressure rise of the vacuum piping 50 due to the desorption gas from the reactor R in the desorption step. Therefore, the pressure (for example, approximately 1 kPa) of the vacuum piping 40 for deaeration is lower than the pressure (for example, approximately 5 kPa) of the vacuum piping 50 for CO₂ recovery.

As illustrated in FIGS. 2 and 3, the gas phase of the first water tank 81 communicates with the vacuum piping 50 for CO₂ recovery through the branch piping 80, and thus the pressure P1 of the gas phase of the first water tank 81 is equal to the pressure of the vacuum piping 50. As illustrated in FIG. 2, when the depressurizing valve 86 is open, and the transfer valve 85, the pressure recovery valve 87, and the drain valve 88 are closed, the gas phase of the second water tank 82 communicates with the vacuum piping 40 for deaeration through the branch piping 44, and thus the pressure P2 of the gas phase of the second water tank 82 is equal to the pressure of the vacuum piping 40.

In this situation, when the transfer valve 85 of the communication passage 83 for communicating the liquid phase of the first water tank 81 with the gas phase of the second water tank 82 is opened, the condensed water stored in the first water tank 81 is efficiently transferred to the second water tank 82 because of a pressure difference (P1 - P2) between the gas phase of the first water tank 81 and the gas phase of the second water tank 82, in addition to gravity.

When the transfer valve 85 and the depressurizing valve 86 are closed and the pressure recovery valve 87 and the drain valve 88 are opened, the atmosphere flows in through the pressure recovery valve 87, then the gas phase of the second water tank 82 is subject to pressure recovery, and the condensed water stored in the second water tank 82 is drained through the drain valve 88 in accordance with gravity.

FIG. 5 is a flowchart illustrating an example of transfer processing performed by the controller 10. The processing of FIG. 5 is started when the DAC apparatus 100 is activated, and is repeatedly performed at predetermined intervals. When the DAC apparatus 100 is activated, the control valves 85 to 88 are closed.

As illustrated in FIG. 5, first, the controller 10 determines whether the water level L1 of the first water tank 81 that has been detected by the water level sensor 11 is equal to or higher than an upper limit water level L1max in S10 (S: processing step). S10 is repeated until an affirmative determination is made.

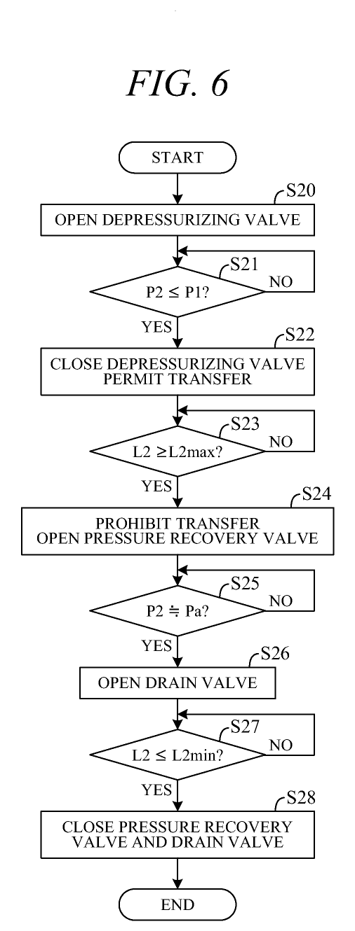

When the water level L1 of the condensed water stored in the first water tank 81 rises to the upper limit water level L1max, the affirmative determination is made in S10, the processing proceeds to S11, and it is determined whether transfer of the condensed water from the first water tank 81 to the second water tank 82 (opening of the transfer valve 85) is permitted in S22 of FIG. 6. S11 is repeated until an affirmative determination is made.

When the affirmative determination is made in S11, the processing proceeds to S12, and the transfer valve 85 is controlled to be opened so as to start transferring the condensed water from the first water tank 81 to the second water tank 82. Next, in S13, it is determined whether the water level L1 of the first water tank 81 that has been detected by the water level sensor 11 is equal to or lower than a lower limit water level L1min (L1min > 0). S13 is repeated until an affirmative determination is made.

When the water level L1 of the first water tank 81 decreases to the lower limit water level L1min, the affirmative determination is made in S13, the processing proceeds to S14, and the transfer valve 85 is controlled to be closed so as to end the transfer of the condensed water from the first water tank 81 to the second water tank 82.

FIG. 6 is a flowchart illustrating an example of water drain processing performed by the controller 10. The processing of FIG. 6 is started when the DAC apparatus 100 is activated, and is repeatedly performed at predetermined intervals. As illustrated in FIG. 6, first, in S20, the controller 10 controls and opens the depressurizing valve 86 to start depressurizing the second water tank 82.

Next, in S21, it is determined whether the pressure P2 of the second water tank 82 that has been detected by the pressure sensor 14 is equal to or lower than the pressure P1 of the first water tank 81 that has been detected by the pressure sensor 12. S21 is repeated until an affirmative determination is made.

When the pressure P2 of the second water tank 82 decreases to become equal to or lower than the pressure P1 of the first water tank 81, the affirmative determination is made in S21, the processing proceeds to S22, and the depressurizing valve 86 is controlled to be closed so as to end depressurizing the second water tank 82. In addition, the transfer of the condensed water from the first water tank 81 to the second water tank 82 (opening of the transfer valve 85) is permitted.

Next, in S23, it is determined whether the water level L2 of the second water tank 82 that has been detected by the water level sensor 13 is equal to or higher than an upper limit water level L2max. S23 is repeated until an affirmative determination is made.

When the water level L2 of the condensed water that has been transferred from the first water tank 81 and then stored in the second water tank 82 rises to the upper limit water level L2max, the affirmative determination is made in S23, the processing proceeds to S24, and the transfer of the condensed water from the first water tank 81 to the second water tank 82 (opening of the transfer valve 85) is prohibited. In addition, the pressure recovery valve 87 is controlled to be opened, and the pressure recovery of the second water tank 82 is started.

Next, in S25, it is determined whether the pressure P2 of the second water tank 82 that has been detected by the pressure sensor 14 is approximately atmospheric pressure Pa. S25 is repeated until an affirmative determination is made.

When the pressure P2 in the second water tank 82 rises to approximately atmospheric pressure Pa, the affirmative determination is made in S25, the processing proceeds to S26, and the drain valve 88 is controlled to be opened so as to start draining the water from the second water tank 82. Next, in S27, it is determined whether the water level L2 of the second water tank 82 that has been detected by the water level sensor 13 is equal to or lower than a lower limit water level L2min (L2min ≥ 0). S27 is repeated until an affirmative determination is made.

When the water level L2 of the second water tank 82 decreases to the lower limit water level L2min, the affirmative determination is made in S27, the processing proceeds to S28, and the pressure recovery valve 87 and the drain valve 88 are controlled to be closed so as to end draining the water from the second water tank 82.

The condensed water is transferred so that the water level L1 of the first water tank 81 always exceeds the lower limit water level L1min, and is lower than the upper limit water level L1max. Thus, the liquid phase and the gas phase of the first water tank 81 are ensured (S10 and S12 to S14 in FIG. 5). By ensuring the liquid phase of the first water tank 81, it becomes possible to certainly seal the gas phase of the first water tank 81, which communicates with the vacuum piping 50, from the vacuum piping 40 and the second water tank 82, which communicates with the external space. By ensuring the gas phase of the first water tank 81, it becomes possible to certainly prevent a hindrance of gas-liquid separation of the stored water, in the gas-liquid separator 8.

By communicating the second water tank 82 with the vacuum piping 40, depressurizing the second water tank 82, and then transferring the condensed water, it becomes possible to efficiently transfer the condensed water without flowing back the condensed water because of the pressure difference (P1 - P2) between the first water tank 81 and the second water tank 82 (S11 to S12 in FIG. 5 and S20 to S22 in FIG. 6).

By draining the water from the second water tank 82 so that the water level L2 in the second water tank 82 is always lower than the upper limit water level L2max, it becomes possible to ensure the gas phase in the second water tank 82, and to certainly prevent the stored water from flowing back to the vacuum piping 40 (S23 and S26 in FIG. 6). By communicating the second water tank 82 with the external space, recovering the pressure, and then draining the water, it becomes possible to smoothly drain the water (S24 to S26). In recovering the pressure in the second water tank 82, by prohibiting the transfer of the condensed water, that is, communication between the first water tank 81 and the second water tank 82, it becomes possible to certainly prevent a backflow of the condensed water from the second water tank 82 to the first water tank 81 (S24).

According to the embodiments of the present invention, the following operation and effects are achievable.

(1) The DAC apparatus 100 includes: the reactor R in which an adsorbent for adsorbing or absorbing CO₂ and water is provided; the vacuum pump 5, which is connected with the reactor R through the vacuum piping 50, and which sucks the desorption gas from the adsorbent; the vacuum pump 4, which is connected with the reactor R through the vacuum piping 40, and which sucks the residual atmosphere that is not adsorbed to the adsorbent; the gas-liquid separator 8, which is provided on the vacuum piping 50, and which separates the water from the desorption gas; the first water tank 81, which stores the water separated by the gas-liquid separator 8; the second water tank 82 connected with the vacuum piping 40; the communication passage 83, which communicates the first water tank 81 with the second water tank 82; the transfer valve 85 provided on the communication passage 83; and the controller 10 configured to control the transfer valve 85 for the water level L1 of the first water tank 81 to exceed the lower limit water level L1min (FIGS. 1- 4, and S12 to S14 in FIG. 5).

In this manner, by providing the gas-liquid separator 8 on the vacuum piping 50 to separate and remove the water from the desorption gas, it becomes possible to reduce the pressure of the desorption gas in the vacuum piping 50, and to improve the pump efficiency of the vacuum pump 5 and the CO₂ recovery efficiency particularly in the former half of the desorption step in which the desorption amount of water is large. Thus, the CO₂ recovery efficiency of the entire apparatus can be improved. In addition, the water stored in the first water tank 81 can be efficiently transferred to the second water tank 82 because of the pressure difference (P1 - P2) between the first water tank 81, which is connected with the vacuum piping 50 for CO₂ recovery, and the second water tank 82, which is connected with the vacuum piping 40 for deaeration. Further, by controlling the transfer valve 85 and ensuring the liquid phase of the first water tank 81, it becomes possible to certainly seal the gas phase of the first water tank 81, which communicates with the vacuum piping 50 for CO₂ recovery, from the second water tank 82, which communicates with the vacuum piping 40 for deaeration.

(2) The gas-liquid separator 8 is a heat exchanger that condenses water contained in the desorption gas using a refrigerant (FIG. 3). Therefore, the water can be separated from the desorption gas with a simple configuration. In addition, the condensed water can be used for cooling or the like of other equipment.

(3) The controller 10 controls and opens the transfer valve 85 on condition that the second water tank 82 communicates with the vacuum piping 40 for deaeration (S11 to S12 in FIG. 5 and S20 to S22 in FIG. 6). In this case, the water stored in the first water tank 81 can be efficiently transferred to the second water tank 82 without flowing back because of the pressure difference (P1 - P2) between the gas phase of the first water tank 81, which communicates with the vacuum piping 50 for CO₂ recovery, and the gas phase of the second water tank 82, which communicates with the vacuum piping 40 for deaeration.

(4) The DAC apparatus 100 further includes the drain valve 88 provided for the second water tank 82 (FIG. 2). The controller 10 controls the transfer valve 85 so that the water level L1 of the first water tank 81 is lower than the upper limit water level L1max (S10 and S12 in FIG. 5), and also controls the drain valve 88 so that the water level L2 of the second water tank 82 is lower than the upper limit water level L2max (S23 and S26 in FIG. 6). Thus, the gas phases of the first water tank 81 and the second water tank 82 are ensured, and thus it becomes possible to certainly prevent a hindrance of gas-liquid separation of the water stored in the first water tank 81 in the gas-liquid separator 8, and to certainly prevent the water stored in the second water tank 82 from flowing back to the vacuum piping 40.

(5) The DAC apparatus 100 further includes the pressure recovery valve 87 provided for the second water tank 82 (FIG. 2). The controller 10 controls and opens the drain valve 88 on condition that the pressure recovery valve 87 is open and the gas phase of the second water tank 82 is pressure-recovered (S24 to S26 in FIG. 6). Thus, the water can be smoothly drained from the second water tank 82 through the drain valve 88.

(6) The second water tank 82 is provided to be lower than the first water tank 81 in a gravity direction (FIG. 2). Thus, the water stored in the first water tank 81 can be transferred to the second water tank 82 through the communication passage 83 in accordance with gravity.

(7) The DAC apparatus 100 further includes the check valve 84, which is provided on the communication passage 83, and which blocks the flow of a fluid from the second water tank 82 to the first water tank 81 (FIG. 2). Thus, a backflow of the water in the communication passage 83 can be prevented.

In the above embodiment, an example in which the water level sensors 11 and 13 are respectively provided in the water tanks 81 and 82 to detect the water levels L1 and L2 has been described with reference to FIGS. 2 and 4 and the like, but the water level of the water tank is not limited to the detection using the water level sensor. For example, the controller 10 may estimate the water levels L1 and L2 of the water tanks 81 and 82, based on the environmental condition such as humidity or temperature, an operating condition of the DAC apparatus, or the like. In this case, the configurations of the water tanks 81 and 82 can be simplified, and the vacuum state and the heat insulation state can be easily maintained.

The above embodiment can be combined as desired with one or more of the aforesaid modifications. The modifications can also be combined with one another.

According to the present invention, it becomes possible to improve the CO₂ recovery efficiency of the DAC apparatus.

Above, while the present invention has been described with reference to the preferred embodiments thereof, it will be understood, by those skilled in the art, that various changes and modifications may be made thereto without departing from the scope of the appended claims.

1. A DAC apparatus configured to recover CO₂ in the atmosphere, comprising:
an adsorption chamber provided with an adsorbent for adsorbing or absorbing CO₂ and water;
a vacuum pump for recovery connected with the adsorption chamber through vacuum piping for recovery and configured to suck desorption gas from the adsorbent;
a vacuum pump for deaeration connected with the adsorption chamber through vacuum piping for deaeration and configured to suck residual atmosphere not absorbed to the adsorbent;
a gas-liquid separator provided on the vacuum piping for recovery and configured to separate water from the desorption gas;
a first water tank configured to store the water separated by the gas-liquid separator;
a second water tank connected with the vacuum piping for deaeration;
a communication passage communicating the first water tank with the second water tank;
an on-off valve provided on the communication passage; and
a controller configured to control the on-off valve for a water level of the first water tank to exceed a lower limit water level.

2. The DAC apparatus according to claim 1, wherein
the gas-liquid separator is a heat exchanger configured to condense the water contained in the desorption gas using a refrigerant.

3. The DAC apparatus according to claim 1, wherein
the controller controls and opens the on-off valve on condition that the second water tank communicates with the vacuum piping for deaeration.

4. The DAC apparatus according to claim 1, further comprising:
a drain valve provided for the second water tank, wherein
the controller controls the on-off valve so that the water level of the first water tank is lower than a first upper limit water level, and controls the drain valve so that the water level of the second water tank is lower than a second upper limit water level.

5. The DAC apparatus according to claim 4, further comprising:
a pressure recovery valve provided for the second water tank, wherein
the controller controls and opens the drain valve on condition that the pressure recovery valve is open and a gas phase of the second water tank is pressure-recovered.

6. The DAC apparatus according to claim 1, wherein
the second water tank is provided to be lower than the first water tank in a gravity direction.

7. The DAC apparatus according to claim 1, further comprising:
a check valve provided on the communication passage and configured to block flow of fluid from the second water tank to the first water tank.
